(19) United States
(12) Patent Application Publication
(10) Pub. No.: US 2016/0143016 A1
(43) Pub. Date: May 19, 2016

(54) DEVICES FOR SUPPLYING SERVICE INFORMATION FOR A MICROWAVE LINK

(71) Applicant: Orange, Paris (FR)

(72) Inventors: Philippe Chanclou, Lannion (FR); Anna Pizzinat, Ploubezre (FR)

(21) Appl. No.: 14/899,543

(22) PCT Filed: Jun. 17, 2014
(86) PCT No.: PCT/FR2014/051500

§ 371 Date: Dec. 17, 2015

(30) Foreign Application Priority Data
Jun. 19, 2013 (FR) 1355774

(51) Int. Cl. H04W 72/04; H04W 76/02

(52) U.S. Cl. CPC H04W 72/0406; H04W 76/021

(57) ABSTRACT

In a first aspect, the present invention provides a base band unit (BBU) (or a remote radio head (RRH)), including means for supplying an identifier of said unit to a microwave head (MW^{BBU} or MW^{RRH})) connected to said BBU (or RRH) unit, the identifier being located within at least one predetermined control subchannel of a signal for digital radio. In a second aspect, the invention also provides a base band unit (BBU) (or a remote radio head (RRH)), including means for receiving an identifier of an RRH (or BBU) unit from a microwave head (MW^{BBU}, or MW^{RRH})) to which said BBU (or RRH) unit is connected, the identifier being contained in at least one predetermined control subchannel of a signal for digital radio.

The present invention relates to digital communications when the data signal is conveyed in a microwave (MW) beam.

The invention relates more particularly to radio communications, in particular using the common public radio interface (CPRI) standard. The CPRI standard was introduced by a working group made up of manufacturers of equipment for mobile networks (cf. the web site www.cpri.info). This standard has been reexamined by the open radio interface (ORI) group of the European Telecommunications Standards Institute (ETSI), which is seeking to develop a standard that is fully interoperable with the ITU-T SG15 Q2, ITU-T SG15 Q6, and IEEE 802.3 standards, which three standards define so-called wavelength division multiplexing passive optical network (WDM-PON) technologies. The data rates that can be transported in compliance with the CPRI standard are very high (from 600 megabits per second (Mbit/s) up to several gigabits per second (Gbit/s)).

It is particularly intended to make use of CPRI signals for the “fronthaul” (the link coming from the core network and going to a radio cell over the last kilometer). By way of example, such links may make use of optical fiber as the transmission medium for CPRI signals (where this technology is known as digital radio over fiber (DRoF)). However, such links could equally well make use of MW beams as the transmission medium for CPRI signals (where this technology is referred to below as digital radio over microwave (DRoM)). By way of example, patent application WO2008/092069 discloses a distributed base station system for transmitting data at high speed between an Internet protocol (IP) gateway and at least one remote antenna; that system comprises a base station connected to the Internet gateway and a remote radio frequency (RF) converter connected to the antenna; the base station and the RF converter exchange data via a transport channel, which may in particular be either a millimeter radio link (e.g. operating in “band E” at 70 gigahertz (GHz)), or else a microwave link.

It is therefore important to have satisfactory technical solutions available for making the operation, the administration, and the maintenance of such MW links both secure and simple.

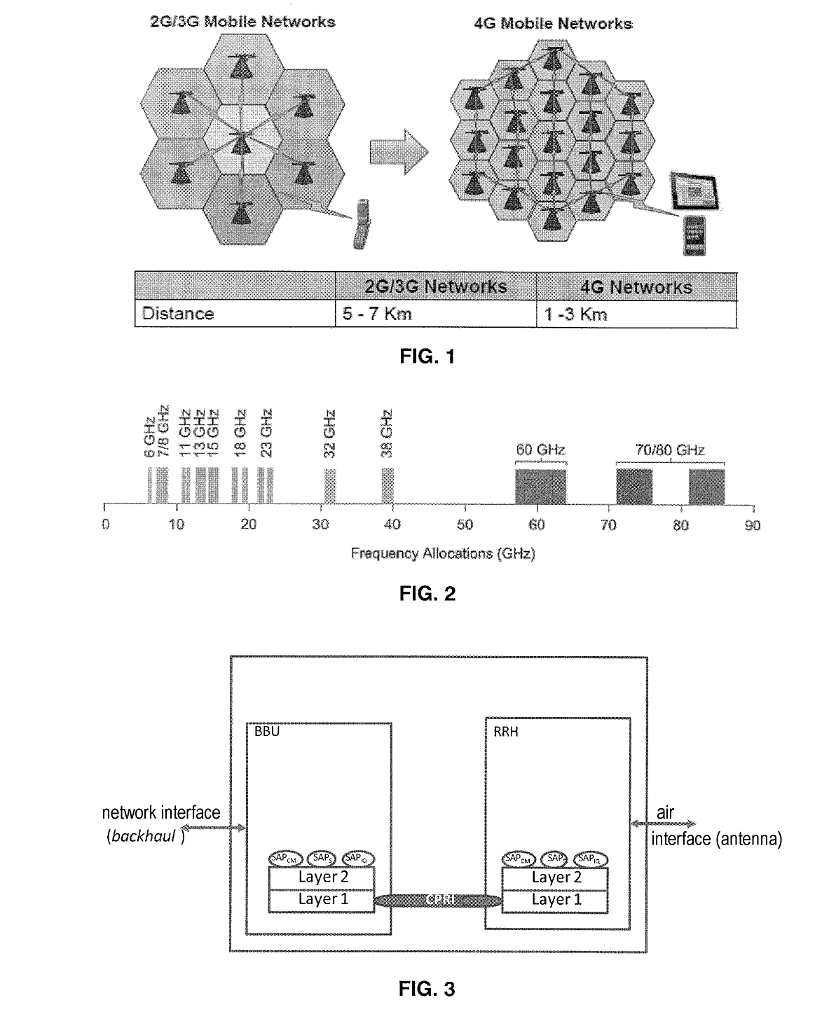

It may be observed that MW technology is particularly well adapted to long-term evolution (LTE) communications, where LTE designates a set of mobile telecommunications technologies that are standardized in their “advanced” version (LTE Advanced)—also known as “fourth generation” (4G)—in the third generation partnership project (3GPP) document “Release 10”. As shown in FIG. 1, 4G cells are of dimensions (1 kilometer (km) to 3 km) that are smaller than 2G (GSM) cells or 3G (UMTS) cells (5 km to 7 km), and these shorter distances are well suited to transporting data by MW beams.

For LTE networks, and also for “small” or “micro” cell networks, it can thus be preferable to use the MW transport mode instead of optical fiber transport, in particular because of the relatively high cost of deploying an optical fiber network.

Several frequency bands can be used for transmitting DRoM signals, as shown in FIG. 2 for European standards. Frequencies of less than 38 GHz are difficult to make compatible with CPRI signals, since they are in widespread use for various applications and run the risk of being congested. Only frequency bands around 40 GHz, 60 GHz, and 70/80 GHz present channels that are wide enough to provide data rates of Gbit/s order or more over distances exceeding about one hundred meters. In particular, the above-mentioned frequency band known as “band E”, which is constituted by two channels each having a width of 5 GHz, namely in the range 71 GHz to 76 GHz and in the range 81 GHz to 86 GHz, is very promising for transporting CPRI signals; it is possible to transport data rates in those bands at about 2.5 Gbit/s with simple modulation; furthermore, attenuation due to atmospheric absorption in those bands is about 0.5 decibels per kilometer (dB/km), whereas it is about 15 dB/km at 60 GHz, thus making it possible under good weather conditions to reach distances of several kilometers (it should be observed in this respect that the quality of MW links becomes significantly lower in the rain).

It should be recalled that the gain and the directivity of an antenna increase with increasing frequency. Consequently, antennas transmitting in band E naturally present gain and directivity that is higher than antennas having the same dimensions, but operating at conventional frequencies (less than 40 GHz). It is thus easy to make beams of narrow section (known as “pencil” beams) for transmission in band E, however that requires stricter conditions than with conventional frequencies for the accuracy with which an MW beam is pointed between the transmitter and the receiver.

A conventional base station complying with the CPRI standard has a remote radio head (RRH), also referred to as radio equipment (RE), together with a base band unit (BBU), that is also referred to as a radio equipment controller (REC), which are connected together by optical cable or by MW beam, and which communicate with CPRI signals.

It should be recalled (cf. the on-line encyclopedia Wikipedia) that RRH refers to a control system managed by a radio operator communicating with a radio transceiver via a wireless or electrical interface. RRHs have become one of the most important subsystems for present-day base stations. In a base station, the RRH contains RF circuits together with analog-to-digital and digital-to-analog converters, and also high/low converters. RRHs possess capacities for processing and administering the functions of base stations, and they facilitate locating zones where radio coverage is insufficient.

Present-day RRHs make use of the most recent RF component technology, including gallium nitride (GaN) RF power amplifiers and envelope tracking technology within the power amplifier. RRHs are about the size of a suitcase, they weigh about 15 kilograms (kg), and they are usually placed at the top of an antenna of the base station.

BBUs are generally in the form of an electronic equipment cabinet.

In certain base stations complying with the CPRI standard, the RRU and the BBU are operated in a single unit. However, the present invention relates to base stations that are said to be “distributed”, in which the RRH and the BBU are situated a certain distance apart.

In certain distributed base stations, the BBU is arranged at the bottom of the antenna carrying the RRH, and the distance between the RRH and the BBU is then a few meters. It is then convenient to make use of an optical fiber or an MW beam for connecting the RRH to the BBU.

In distributed base stations adapted to wireless communications techniques such as GSM, WiMAX, UMTS, or LTE, the BBU may be situated at a considerable distance from the RRH, which distance may for example be as much as a few tens of kilometers. Such equipment may be used to extend coverage of a base station, e.g. in rural zones or in tunnels. The BBUs belonging to a plurality of base stations may then be colocalized in a common central office (CO), leading to the concept of BBU “hostelling”. This BBU hostelling architecture is attracting great interest because of its advantages: it solves security problems in LTE, and it enables the “backhaul” (i.e. the direct link with the core network) to be simplified; more precisely, by comparison with other known backhaul architectures, it is better adapted to implementing the changes of LTE advanced technology, and it also makes it possible to achieve savings (in terms of energy, deployment, etc.). That is why several network operators have already begun to deploy BBU hostelling architectures.

A plurality of point-to-point links is used for transporting CPRI traffic. It is generally necessary to install one MW link per RRH; by way of example, a mobile communications station having a three-sector antenna requires three MW links.

It is therefore necessary to superpose a plurality of MW beams (main starting point, main destination point) that may differ in terms of the frequency of the associated MW signal. Using the E frequency band, in particular, enables a plurality of transmissions to be superposed without risk of mutual interference. Furthermore, a beam at a given frequency can convey a plurality of transmissions (bidirectional and/or multiplexed).

Under such conditions, when installing and using MW links between an RRH and a BBU, it is necessary to be able to solve the following problems.

A first problem is finding the “right” MW beam. In other words, it must be possible to identify which BBU and/or RRH is associated with a given MW beam.

A second problem is to know how to obtain service information, when required, such as: frequency band used; type of modulation; data rate; transmit power; etc.

In the prior art, in order to identify the characteristics of the signal conveyed in an MW link while the link is in operation, being administered, or being maintained, it is necessary to involve a technician for carrying out appropriate steps: unfortunately, that method of identification is clearly expensive in terms of the time taken and in terms of labor.

In a first aspect, the present invention thus provides a BBU (or RRH) unit, including means for supplying an identifier of said unit to a microwave head connected to said BBU (or RRH) unit, the identifier being located within at least one predetermined control subchannel of a signal for digital radio.

Thus, the invention provides for a BBU (or RRH) unit to have an identifier allocated thereto (by a manufacturer of the unit, or by a network operator, for example), and for the identifier to be inserted in an MW beam coming from said BBU (or RRH) via an MW head. Advantageously, this insertion is entirely automatic.

In a second aspect, the present invention provides a BBU (or RRH) unit including means for receiving an identifier of an RRH (or BBU) unit from a microwave head to which said BBU (or RRH) unit is connected, the identifier being contained in at least one predetermined control subchannel of a signal for digital radio.

By means of these provisions, a BBU (or RRH) unit can, in fully automatic manner, read an identifier in a signal conveyed by a microwave beam received by said BBU (or RRH) unit via a microwave head, which identifier has been allocated to an RRH (or BBU) unit in accordance with the invention.

According to particular characteristics, said BBU (or RRH) unit further comprises means for storing the identifier of an RRH (or BBU) unit received as described briefly above.

By means of these provisions, the BBU (or RRH) unit can store said received identifier conveniently in memory.

This makes it possible in particular (by combining said first and second aspects of the invention) to enable a BBU and an RRH belonging to a single distributed base station to exchange their respective identifiers, and to do so in a manner that is entirely automatic. Determining the identifier of a BBU unit or of an RRH unit is thus made very easy.

In the brief summary above of the first and second aspects, the word “predetermined” means that the BBU and RRH units both know which control subchannel to use for inserting or reading said identifier, either as a result of a prior agreement between the managers of those units, or else as a result of a standard or of general practice used in the signals for digital radio industry.

It should be observed that it is possible to make the BBU unit or the RRH unit in the context of software instructions and/or in the context of electronic circuits.

The invention thus also provides a computer program that is downloadable from a communications network and/or stored on a computer readable medium and/or executable by a microprocessor. Said program is remarkable in that it comprises instructions for managing the operation of a BBU unit or of an RRH unit as described briefly above, when it is executed on a computer.

The advantages provided by the computer program are essentially the same as those provided by said units.

The invention thus makes good use of the capacities of signals conveyed by a microwave beam. That is why, in a third aspect, the invention also provides a signal conveyed by a microwave beam. Said signal is remarkable in that it includes a predetermined control subchannel (or a plurality of predetermined control subchannels) for containing an identifier of a BBU unit or of an RRH unit.

The characteristics of the signal of the invention may advantageously be combined with the characteristics defined by the CPRI standard; however they may also be combined with other types of signal for digital radio.

Other aspects and advantages of the invention appear on reading the following detailed description of particular embodiments given as non-limiting examples.

The description refers to the accompanying figures, in which:

FIG. 1, described above, is a diagram showing a 2G or 3G cellular network and a 4G cellular network;

FIG. 2, described above, shows a series of frequency bands allocated to various types of radiocommunications in Europe;

FIG. 3 is a diagram showing a conventional base station in compliance with the CPRI standard;

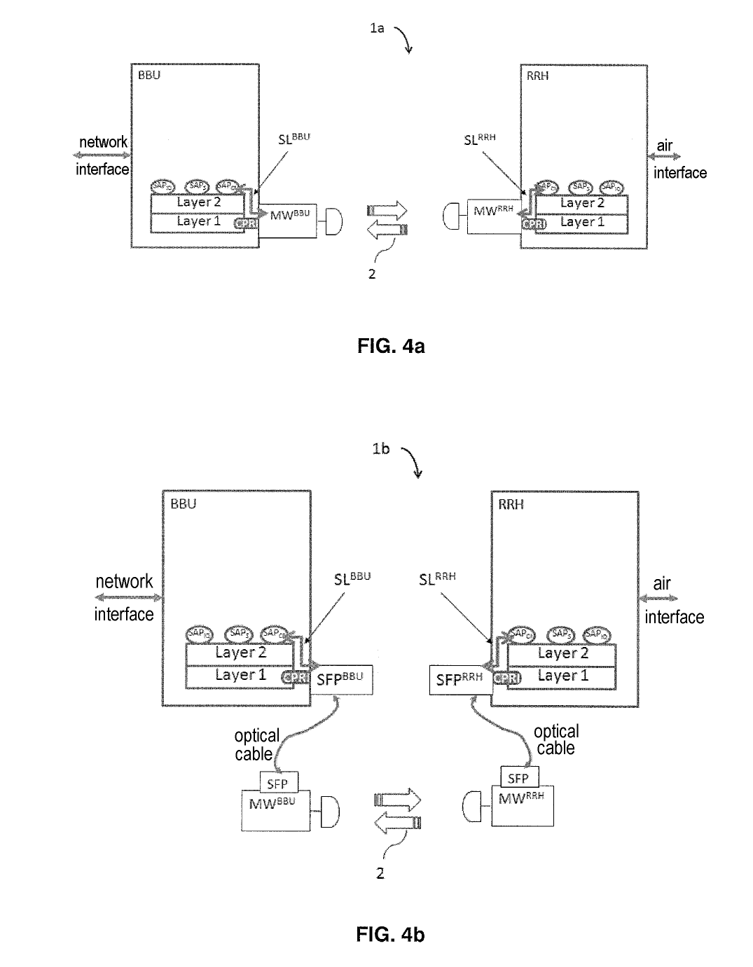

FIG. 4a is a diagram showing a distributed base station in a first embodiment of the invention; and

FIG. 4b is a diagram showing a distributed base station in a second embodiment of the invention.

As explained briefly above, the BBU (or RRH) unit of the present invention has means for supplying an identifier of the unit to an MW head that is connected to the BBU (or RRH) unit, the identifier being located within at least one predetermined control subchannel of a signal for digital radio. Correspondingly, the BBU (or RRH) unit of the present invention has means for receiving an identifier of an RRH (or BBU) unit from the MW head to which the BBU (or RRH) unit is connected, which identifier is contained in at least one predetermined control subchannel of a signal for digital radio.

Optionally, it is possible in the same manner to produce and transmit or read other service information concerning the RRH or the BBU in a predetermined control subchannel (or in a plurality of predetermined control subchannels) of a signal for digital radio sent in an MW beam, which information may comprise:
the name of the manufacturer;
the hardware configuration (protections, repeater, meshing);
the maximum range of the MW beam;
the pointing accuracy of the MW beam;
the power transmitted by the transmitter unit, the detection threshold of the receiver unit, and the acceptable radiofrequency budget (i.e. the difference between the transmitted power and the detection threshold);
the frequency band used;
the type of modulation;
the data rate;
the latency time delay;
the type of channel coding;
the temperature;
an alarm signal (e.g. to indicate a risk of bad weather); and/or
whether or not the coordinated multipoint transmission (CoMP) standard is being implemented (in compliance with the CoMP standard, it is possible in LTE-Advanced to coordinate and combine signals associated with a plurality of antennas).

The invention is illustrated below by way of example in the context of the above-mentioned CPRI standard. It is thus appropriate to begin by recalling certain properties of the CPRI standard, and more particularly Section 4.2.7.4 in Version 5.0 of this standard.

Payload data is conveyed in frames, and frames are themselves grouped together in hyperframes.

In addition to payload data, each hyperframe contains 256 control words, and each group contains four control words constituting a subchannel. The standard also makes provision, without further details, for a manufacturer to have the possibility of transmitting proprietary information in nine specific subchannels that are said to be “reserved” subchannels, i.e. in 36 control words.

FIG. 3 is a diagram showing a conventional base station in compliance with the CPRI standard.

This base station comprises a BBU that is connected externally to the core network via a backhaul link, and an RRH that is connected externally to an antenna, also referred to as an “air interface”. The BBU and the RRH are connected together internally by an optical cable or an MW beam conveying the CPRI signal. As explained above, such a station may be a single unit or it may be distributed.

Both in the BBU and in the RRH, there can be seen:
a physical layer (layer 1) comprising the electrical characteristics, the type of multiplexing (e.g. time division multiplexing) used for the various data streams, and the low level signaling; and
a data link layer (layer 2) comprising media access control, stream control, and protection of the control and management information streams.

More particularly, concerning said data link layer, reference points are defined (associated with specific software applications) for measuring performance over each communication link: these points are known as service access points (SAPs); these include in particular the SAP_{CM} for control and management, the SAP_{S} for synchronization, and the SAP_{IQ} for user purposes.

Furthermore, in the CPRI standard, a BBU or RRH unit is suitable for supplying a certain amount of service information to a CPRI interface of the unit (by means of said SAPs, and via a service link) over at least one control subchannel of a CPRI signal. Correspondingly, in the CPRI standard, a CPRI interface of a BBU or RRH unit enables that unit to be supplied with a certain amount of service information (by means of said SAPs, and via a service link), which information is contained in at least one control subchannel of a CPRI signal received by said SFP.

Various embodiments of the invention are described below.

In these embodiments, said identifier of the BBU (or RRH) unit is produced by the access point SAP_{CM} of the BBU (or RRH) unit. After reception, said identifier of the RRH (or BBU) unit is supplied to the access point SAP_{CM} of the BBU (or RRH) unit.

Furthermore, the BBU (or RRH) unit is suitable for storing said identifier of the RRH (or BBU) unit.

FIG. 4a shows a first embodiment of the invention.

This figure is a diagram showing a distributed base station 1a.

The base station la comprises a BBU that is connected to an MW head, referenced MW^{BBU}. This head MW^{BBU} is connected to the access point SAP_{CM} of the BBU unit by means of an electrical service link SL^{BBU}.

The base station la also has at least one RRH having an MW head, referenced MW^{RRH}, connected thereto. This head MW^{RRH} is connected to the access point SAP_{CM} of the RRH unit by means of an electrical service link SL^{RRH}.

The head MW^{BBU} exchanges a CPRI signal with the head MW^{RRH} of each RRH, which signal is conveyed in an MW beam 2. When there are a plurality of RRHs, the respective MW beams (thus pointing in respective different directions from the BBU) are preferably at mutually different frequencies (e.g. 40 GHz, 60 GHz, and 80 GHz when there are three beams); nevertheless, in any event, the invention advantageously makes it possible to know which CPRI signal is conveyed by a given MW beam.

With reference to FIG. 4b, there follows a description of a second embodiment of the invention.

FIG. 4b is a diagram showing a distributed base station 1b.

The base station 1b comprises a BBU connected to an MW head, referenced MW^{BBU}, via an optical cable having an optical transceiver SFP at each end. The SFP fastened on the CPRI interface of the BBU, referenced SFP^{BBU}, is connected to the access point SAP_{CM} of this BBU unit by means of an electrical service link SL^{BBU}.

The base station 1b also has an RRH having an MW head, referenced MW^{RRH}, connected thereto via an optical cable carrying an optical transceiver SFP at each end. The SFP fastened to the CPRI interface of the RRH, referenced SFP^{RRH}, is connected to the access point SAP_{CM} of the RRH unit by means of an electrical service link SL^{RRH}.

In this respect, it should be recalled (cf. Wikipedia) that an SFP (initials of small form-factor pluggable) is a “hot-pluggable” compact transceiver that is used in telecommunications. The structure of SFPs and of the associated electrical interfaces is specified in the document INF-8074i presented to the Small Form-Factor (SFF) Committee by an association of network component manufacturers and distributors known as the Multisource Agreement (MSA) Association. The SFP is arranged between a mother card of the network device (for a switch, a router, a media converter, or an analogous device) and a network cable made of copper or constituted by an optical fiber. SFPs are compatible with various telecommunications standards, such as CPRI, but also with synchronous optical networking (SONET), Gigabit Ethernet, and Fiber Channel. SFPs are available with various types of transmitter and receiver, thus making it possible in particular with optical fiber links to select the transceiver that is appropriate for each link so as to provide the optical range required on the type of optical fiber that is available (e.g. a multimode fiber or a monomode fiber).

In particular, an SFP in accordance with above-mentioned document INF-8074i is suitable, when connected to the interface between a BBU or an RRH and an optical cable:
for transmitting any CPRI signal received from the BBU or RRH unit into said optical cable; and
for transmitting any CPRI signal received from the optical cable to the BBU or RRH unit.

Each optical cable thus provides for bidirectional transmission of a CPRI signal. Furthermore:
the BBU (or RRH) unit is suitable for supplying an identifier of the unit to the SFP that is fastened on the CPRI interface of said BBU (or RRH) unit, which identifier is supplied within at least one predetermined control subchannel of a CPRI signal; and
the BBU (or RRH) unit is suitable for receiving an identifier of an RRH (or BBU) unit from the SFP fastened on its own CPRI interface, which identifier is contained in at least one predetermined control subchannel of said CPRI signal.

The head MW^{BBU} and the head MW^{RRH} exchange a CPRI signal conveyed in an MW beam 2, or a plurality of CPRI signals conveyed in a plurality of superposed respective MW beams 2. It is also possible to envisage fastening firstly a plurality of SFPs on the BBU, and secondly a plurality of respective SFPs on respective RRHs, or on an RRH having an antenna with a plurality of sectors, so as to transmit a plurality of respective CPRI signals that are conveyed in a plurality of respective MW beams between a plurality of respective pairs of MW heads.

With a plurality of CPRI signals, the respective MW beams preferably use mutually different frequencies; whether it is the case or not, the invention advantageously makes it possible to know which CPRI signal is conveyed by a given MW beam.

Finally, it is mentioned that the present invention can be performed within distributed base stations (whether or not they comply with the CPRI standard) by means of software and/or hardware components.

The software components may be incorporated in a conventional computer program for managing such a network node. That is why, as mentioned above, the present invention also provides a computer system. The computer system comprises in conventional manner a central processor unit using signals to control a memory, and also an input unit and an output unit. Furthermore, the computer system may be used for executing a computer program including instructions for managing the operation of a BBU unit or an RRH unit of the invention.

The invention thus also provides a computer program that is downloadable from a communications network, e.g. an Internet type network, and/or that is executable by a microprocessor. The program may use any programming language, and may be in the form of source code, object code, or of code intermediate between source code and object code, such as in a partially complied form or in any other desirable form.

The program may be stored in a computer readable medium. The invention thus provides a data medium that is non-removable or partially or completely removable that is readable by a computer, and that includes instructions of a computer program as mentioned above.

The data medium may be any entity or device capable of storing the program. For example, the medium may comprise storage means such as a read only memory (ROM), e.g. a compact disk (CD) ROM, or a microelectronic circuit ROM, or magnetic recording means, such as a hard disk, or indeed a universal serial bus (USB) flash drive.

Furthermore, the data medium may be a transmissible medium such as an electrical or optical signal suitable for being conveyed via an electrical or optical cable, by radio, or by other means. In a variant, the data medium may be an integrated circuit in which the program is incorporated, which circuit is adapted to be used in managing the operation of a BBU unit or an RRH unit of the invention.

1. A base band unit (BBU) (or a remote radio head (RRH)), characterized in that it includes means for supplying an identifier of said unit to a microwave head (MW^{BBU} or MW^{RRH}) connected to said BBU (or RRH) unit, the identifier being located within at least one predetermined control subchannel of a signal for digital radio.

2. A BBU (or RRH) unit according to claim 1, characterized in that said identifier of the BBU (or RRH) unit is produced by a service access point dedicated to control and management (SAP_{CM}) of the BBU (or RRH) unit.

3. A base band unit (BBU) (or a remote radio head (RRH)), characterized in that it includes means for receiving an identifier of an RRH (or BBU) unit from a microwave head (MW^{BBU}, or MW^{RRH}) to which said BBU (or RRH) unit is connected, the identifier being contained in at least one predetermined control subchannel of a signal for digital radio.

4. A BBU (or RRH) unit, characterized in that it further comprises means for storing the identifier of an RRH (or BBU) unit received in accordance with claim 3.

5. A BBU (or RRH) unit according to claim 3, characterized in that said identifier of the RRH (or BBU) unit is supplied to a service access point dedicated to control and management (SAP_{CM}) of the BBU (or RRH) unit.

6. Non-removable, or partially or completely removable, data storage means including computer program code instructions for managing operation of a base band unit (BBU) (or of a remote radio head (RRH)), characterized in that it includes means for supplying an identifier of said unit to a microwave head (MW^{BBU} or MW^{RRH}) connected to said BBU (or RRH) unit, the identifier being located within at least one predetermined control subchannel of a signal for digital radio.

7. A computer program that is downloadable from a communications network and/or stored on a computer readable medium and/or executable by a microprocessor, the program being characterized in that it comprises instructions for managing operation of a base band unit (BBU) (or of a remote radio head (RRH)), when executed on a computer, characterized in that it includes means for supplying an identifier of said unit to a microwave head (MW^{BBU} or MW^{RRH}) connected to said BBU (or RRH) unit, the identifier being located within at least one predetermined control subchannel of a signal for digital radio.

8. A signal conveyed by a microwave beam, the signal being characterized in that it includes a predetermined control subchannel (or a plurality of predetermined control subchannels) for containing an identifier of a base band unit (BBU) or of a remote radio head (RRH) unit.

9. A BBU (or RRH) unit according to claim 4, characterized in that said identifier of the RRH (or BBU) unit is supplied to a service access point dedicated to control and management (SAP_{CM}) of the BBU (or RRH) unit.
